(19) United States
(12) Patent Application Publication
(10) Pub. No.: US 2025/0170642 A1
(43) Pub. Date: May 29, 2025

(54) POWDER, METAL PART, ELECTRICAL CONTACT, METHOD OF MANUFACTURING POWDER, AND METHOD OF MANUFACTURING METAL PART

(71) Applicants: Sumitomo Electric Industries, Ltd., Osaka-shi, Osaka (JP); Sumitomo Electric Sintered Alloy, Ltd., Takahashi-shi, Okayama (JP)

(72) Inventors: Fumihiro MAEZAWA, Osaka-shi, Osaka (JP); Tomoyuki ISHIMINE, Osaka-shi, Osaka (JP)

(73) Assignees: Sumitomo Electric Industries, Ltd., Osaka-shi, Osaka (JP); Sumitomo Electric Sintered Alloy, Ltd., Takahashi-shi, Okayama (JP)

(21) Appl. No.: 18/872,296

(22) PCT Filed: Apr. 3, 2023
(86) PCT No.: PCT/JP2023/013853

§ 371 Date: Dec. 6, 2024

(30) Foreign Application Priority Data
Jun. 8, 2022 (WO) PCT/JP2022/023145

(51) Int. Cl. B22F 1/17; B22F 3/16; B22F 9/08; H01H 1/02

(52) U.S. Cl. CPC B22F 1/17; B22F 3/16; B22F 9/082; H01H 1/0206; B22F 2301/10; B22F 2301/20; B22F 2304/10; B22F 2998/10; B22F 2999/00

(57) ABSTRACT

A powder includes a collection of a plurality of particles containing metal elements, the particles each including a matrix and a plurality of precipitates dispersed in the matrix, the matrix including a first component, the precipitates each including a second component, the standard error of the content of the first component in the particles on mass basis being 1.2 or less, the standard error of the content of the second component in the particles on mass basis being 1.2 or less.

### TECHNICAL FIELD

The present disclosure relates to a powder, a metal part, an electrical contact, a method of manufacturing a powder, and a method of manufacturing a metal part. This application claims priority based on the international application PCT/JP2022/023145 dated Jun. 8, 2022, the entire contents of which are incorporated herein by reference.

### BACKGROUND ART

Patent Literature 1 discloses a method of manufacturing an electrical contact material in, for example, a vacuum circuit breaker. This manufacturing method includes a step of obtaining a copper-chromium alloy powder in which chromium is dispersed in a copper matrix, and a step of sintering the copper-chromium alloy powder. The copper-chromium alloy powder is obtained by melting a mixture of copper and chromium and forming minute particles from the molten metal by an atomization process. The content of chromium in the mixture is 5 mass % to 20 mass %.

The melting temperature of the mixture is a temperature in the copper-chromium phase diagram at which the mixture is in a liquid state. Atomizing the mixture in a liquid state produces minute particles in which fine chromium precipitates are dispersed in a copper matrix. Electrical contact materials obtained by sintering such particles have uniform quality and excel in electrical characteristics.

### CITATION LIST

### Patent Literature

PTL 1: Japanese Unexamined Patent Application Publication No. 4-95318

### SUMMARY OF INVENTION

A powder of the present disclosure includes a collection of a plurality of particles containing metal elements, the particles each including a matrix and a plurality of precipitates dispersed in the matrix, the matrix including a first component, the precipitates each including a second component, the standard error of the content of the first component in the particles on mass basis being 1.2 or less, the standard error of the content of the second component in the particles on mass basis being 1.2 or less.

### BRIEF DESCRIPTION OF DRAWINGS

FIG. 1 is a schematic view of an atomizer used in a method of manufacturing a powder described in an embodiment.

FIG. 2 is the copper-chromium phase diagram.

FIG. 3 is the iron-copper phase diagram.

FIG. 4 is a sectional image of a sample prepared to study a powder described in an embodiment.

FIG. 5 is a view illustrating a backscattered electron image of a particle contained in the sample illustrated in FIG. 4.

FIG. 6 is a diagram illustrating a spectrum of the particle illustrated in FIG. 5.

FIG. 7 is a view illustrating a backscattered electron image of a particle different from the particle illustrated in FIG. 5.

FIG. 8 is a bar graph illustrating the copper content and the chromium content in each of a plurality of particles.

FIG. 9 is a bar graph illustrating the average of the copper contents and the average of the chromium contents illustrated in FIG. 8.

FIG. 10 is a bar graph illustrating the distribution of the sizes of precipitates in the particle illustrated in FIG. 5.

FIG. 11 is a view illustrating a backscattered electron image of a cross section of a metal part of TEST EXAMPLE 2.

FIG. 12 is a bar graph illustrating the distribution of the sizes of island portions in the metal part illustrated in FIG. 11.

FIG. 13 is a view illustrating a backscattered electron image of a cross section of a metal part of TEST EXAMPLE 3.

FIG. 14 is a bar graph illustrating the distribution of the sizes of island portions in the metal part illustrated in FIG. 13.

FIG. 15 is a view illustrating a backscattered electron image of a cross section of a metal part of TEST EXAMPLE 4.

FIG. 16 is a bar graph illustrating the distribution of the sizes of island portions in the metal part illustrated in FIG. 15.

FIG. 17 is a schematic view of a vacuum circuit breaker described in an embodiment.

### DETAILED DESCRIPTION

### Problems to be Solved by Present Disclosure

Electrical contact materials desirably contain a large amount of chromium depending on the purpose of use of the electrical contact materials. Unfortunately, it is difficult for an electrical contact material containing a large amount of chromium to attain excellent electrical characteristics because a powder for producing such an electrical contact material tends to be variable in quality. In the copper-chromium phase diagram, the temperature at which a liquid state is achieved is raised with increasing chromium content. If the chromium content is high, the mixture of copper and chromium cannot be brought to a liquid state because otherwise the crucible will not withstand the temperature. The molten mixture heated at a temperature below the upper temperature limit for crucibles contains part of chromium as solid. Atomizing such a molten metal tends to give particles containing coarse chromium precipitates. The coarse precipitates tend to have widely varied grain sizes, and the particles constituting the powder tend to be variable in quality. An electrical contact material obtained by sintering this powder will also be variable in quality. This problem can occur also when the combination is other than copper and chromium.

An object of the present disclosure is to provide a powder that is a collection of particles in which fine precipitates are uniformly dispersed in a matrix, and a method of manufacturing such a powder. Another object of the present disclosure is to provide a metal part in which fine island portions are uniformly dispersed in a matrix portion, and a method of manufacturing such a metal part. Another object of the present disclosure is to provide an electrical contact composed of the metal part of the present disclosure.

### Description of Embodiments of Present Disclosure

First, embodiments of the present disclosure will be recited and described.

<1> A powder according to an embodiment includes a collection of a plurality of particles containing metal elements, the particles each including a matrix and a plurality of precipitates dispersed in the matrix, the matrix including a first component, the precipitates each including a second component, the standard error of the content of the first component in the particles on mass basis being 1.2 or less, the standard error of the content of the second component in the particles on mass basis being 1.2 or less.

The standard error of the content of the first component is determined as follows. First, a sample is prepared in which the powder is dispersed in a resin, and the sample is cut. A predetermined number of the particles are extracted from the cross section of the sample, and the content of the first component in each particle is measured. That is, the contents of the first component corresponding to the respective particles are obtained. The standard error determined from the contents of the first component is the “standard error of the content of the first component in the particles”. The standard error of the content of the second component is determined in the same manner as the standard error of the content of the first component. The standard error of the content of the first component and that of the content of the second component specified here are an indicator showing that the precipitates are dispersed in the particles in the similar state. In other words, the standard errors specified above show that the particles constituting the powder have uniform quality.

The powder according to the embodiment is a collection of a plurality of particles having a small average grain size, and the particles have uniform quality. These characteristics of the powder lead to enhancements in the quality of compacts obtained by pressure molding the powder and in the quality of metal parts obtained by sintering the compacts. Furthermore, the above characteristics of the powder lead to enhancements in the quality of metal parts obtained by metal additive manufacturing using the powder.

Here, the precipitates may have a dendrite shape. In the present specification, the precipitates are evaluated through observation of a cross section of the particle. When the precipitates are dendrites, a precipitate that looks like a grain in one cross section may be three-dimensionally connected to a precipitate that looks like a grain in another cross section.

<2> In the powder of <1>, the standard error of the average grain size of the precipitates in the particles may be 0.1 or less.

The standard error of the average grain size of the precipitates is determined as follows. First, a sample in which the powder is dispersed in a resin is cut, and a predetermined number of the particles are extracted from the cross section. The average grain size of the precipitates contained in each particle is measured. That is, the average grain sizes corresponding to the respective particles are obtained. The standard error determined from the average grain sizes is the “standard error of the average grain size of the precipitates in the particles”. The standard error of the average grain size specified in <2> is an indicator showing that the precipitates are dispersed in the particles in the similar state. This characteristic of the powder leads to enhancements in the quality of compacts obtained by pressure molding the powder and in the quality of sintered bodies obtained by sintering the compacts. Furthermore, the above characteristic of the powder leads to enhancements in the quality of metal parts obtained by metal additive manufacturing using the powder.

<3> In the powder of <1> or <2>, the first component and the second component may be a combination having a two liquid phases separate region in a phase diagram, and the content ratios of the first component and the second component are content ratios falling in the two liquid phases separate region.

The content ratios of the first component and the second component are the ratios of the content of the first component and the content of the second component relative to the total content of the first component and the second component taken as 100 mass %. When the content ratios of the first component and the second component are content ratios falling in the two liquid phases separate region, the particles constituting the powder tend to have uniform quality.

<4> In the powder of any one of <1> to <3>, the average grain size of the particles may be 200 μm or less.

When the average grain size is 200 μm or less, the powder tends to form a dense compact. This is because when the powder has a small average grain size, pressure molding tends to leave small gaps between the particles.

<5> In the powder of any one of <1> to <4>, the average grain size of the precipitates may be 5 μm or less.

The average grain size specified in <5> is an indicator showing that the precipitates are finely dispersed in each particle. This characteristic of the powder leads to enhancements in the quality of compacts obtained by pressure molding the powder and in the quality of sintered bodies obtained by sintering the compacts.

<6> In the powder of any one of <1> to <5>, the maximum grain size of the precipitates may be 20 μm or less.

The maximum grain size specified in <5> is an indicator showing that the precipitates are finely dispersed in each particle. This characteristic of the powder leads to enhancements in the quality of compacts obtained by pressure molding the powder and in the quality of sintered bodies obtained by sintering the compacts.

<7> In the powder of any one of <1> to <6>, the first component may be copper and the second component is chromium.

When the powder has copper as the first component and chromium as the second component, that is, when the powder is a collection of particles in which chromium precipitates are dispersed in a copper matrix, the powder is suited as an electrical contact material. In electrical contacts having a high chromium content, a discharge arc tends to be extinguished in a short time. Thus, the performance of a vacuum circuit breaker is enhanced.

The powder having copper as the first component and chromium as the second component is suited as, for example, an electrical contact material in circuit breakers. The performance of the circuit breaker tends to be enhanced with increasing content of chromium in the powder. For example, the content of chromium in the powder is 40 mass % or more. The content of chromium in the powder is the ratio of chromium relative to the total content of copper and chromium in the powder taken as 100 mass %.

<8> A metal part according to an embodiment includes a metal part containing metal elements, the metal part including a matrix portion and a plurality of island portions dispersed in the matrix portion, the matrix portion including a first component, the island portions each including a second component, the average grain size of the island portions being 10 μm or less.

The average grain size of the island portions is determined as follows. First, a predetermined number of observation fields of view are extracted from a cross section of the metal part, and the grain sizes of all the island portions in each observation field of view are measured. The average of the grain sizes of all the island portions is the “average grain size of the island portions”. The metal part with the above configuration has uniform electrical characteristics throughout.

<9> In the metal part of <8>, the standard error of the average grain size of the island portions in a plurality of different observation fields of view may be 0.3 or less.

The average grain size of the island portions is determined as follows. First, a predetermined number of observation fields of view are extracted from a cross section of the metal part, and the average grain size of the island portions in each observation field of view is measured. That is, the average grain sizes corresponding to the respective observation fields of view are obtained. The standard error determined from the average grain sizes is the “standard error of the average grain size of the island portions in the different observation fields of view”. The metal part with the above configuration has uniform electrical characteristics throughout.

<10> In the metal part of <8> or <9>, the first component and the second component may be a combination having a two liquid phases separate region in a phase diagram.

For example, the metal part is manufactured from the powder according to the embodiment. A compact is obtained by pressure molding the powder according to the embodiment. The metal part is obtained by sintering the compact. The metal part described in <10> has characteristics in accordance with the combination of the first component and the second component.

<11> In the metal part of any one of <8> to <10>, the first component may be copper and the second component is chromium.

When the metal part has copper as the first component and chromium as the second component, the metal part is suited as an electrical contact material in, for example, vacuum circuit breakers. In electrical contacts having a high chromium content, a discharge arc tends to be extinguished in a short time. Thus, the performance of the vacuum circuit breaker is enhanced.

<12> In the metal part of any one of <8> to <11>, the content ratios of the first component and the second component may be content ratios falling in a two liquid phases separate region in a phase diagram.

When the metal part is made of the powder according to the embodiment, the content ratios of the first component and the second component in the metal part fall in a two liquid phases separate region. The metal part described in <12> has characteristics in accordance with the content ratios of the first component and the second component.

Here, the metal part according to the embodiment may be made from an ingredient powder that includes the powder according to the embodiment and an additional powder. In this case, the content ratios of the first component and the second component in the metal part may be changed. When, for example, the ingredient powder includes the powder of the embodiment in which the first component is copper and the second component is chromium, and further includes copper powder, the content ratios of the first component and the second component in the metal part are lower than the content ratios falling in a two liquid phases separate region.

<13> An electrical contact according to an embodiment is composed of the metal part of any one of <8> to <12>.

The electrical contact according to the embodiment is composed of the metal part that has uniform electrical characteristics throughout. Thus, the electrical contact according to the embodiment can suppress malfunctions and other problems.

<14> A method of manufacturing a powder according to an embodiment includes step A of providing a raw material member containing a first component and a second component, step B of melting the raw material member with a high-frequency induction heating device having no crucibles, and step C of atomizing a molten metal obtained in step B into a powder.

The raw material member is a composite that contains the first component and the second component substantially uniformly. The raw material member may be composed of a single kind of a solid or may be composed of a plurality of kinds of solids combined into one piece. The high-frequency induction heating device having no crucibles can heat the raw material member to a temperature equal to or higher than the upper temperature limit for crucibles. The nonuse of crucibles can prevent contamination from crucibles.

The high-frequency induction heating device can heat the raw material member in a short time. Thus, the atomizing in step C can be performed before the first component and the second component separate into two macroscopic liquids in the molten metal. Furthermore, the high-frequency induction heating device generates magnetic fields that stir the molten metal, and the molten metal being subjected to the atomization forms a dispersion in which the molten metal of the second component is finely dispersed in the molten metal of the first component. Thus, the powder that is obtained tends to consist of a plurality of particles having uniform quality.

<15> In an embodiment of the method of manufacturing a powder of <14>, the raw material member may be a compact including a powdery first solid principally containing the first component and a powdery second solid principally containing the second component.

When the raw material member is composed of a compact including the powdery first solid and the powdery second solid, the first component and the second component are uniformly present throughout the raw material member. Thus, the content ratios of the first component and the second component in the molten metal obtained by melting the raw material member tend to be uniform. Thus, the content ratios of the first component and the second component in the particles constituting the powder tend to be uniform.

<16> In an embodiment of the method of manufacturing a powder of <14> or <15>, the first component and the second component may be a combination having a two liquid phases separate region in a phase diagram, the content ratios of the first component and the second component in the raw material member may be content ratios falling in the two liquid phases separate region, and the temperature of the molten metal may be equal to or higher than a temperature in the two liquid phases separate region in the phase diagram.

In the two liquid phases separate region in the phase diagram, both the first component and the second component are liquid. Magnetic fields generated by the high-frequency induction heating device cause the molten metal of the second component to be finely dispersed in the molten metal of the first component. Thus, the powder that is obtained tends to consist of a plurality of particles having uniform quality.

<17> In the method of manufacturing a powder of any one of <14> to <16>, the first component may be copper and the second component may be chromium.

A powder having copper as the first component and chromium as the second component is suited as an electrical contact material in, for example, circuit breakers. The performance of the circuit breaker tends to be enhanced with increasing content of chromium in the powder.

When the content ratios of copper and chromium are content ratios falling in the two liquid phases separate region in the phase diagram, the content of chromium in the total content of copper and chromium is 47 mass % to 80 mass %. The powder obtained in this case has a high chromium content. The powder with a high chromium content is particularly suited as an electrical contact material in circuit breakers.

<18> A method of manufacturing a metal part according to an embodiment includes: pressure molding the powder of any one of <1> to <7> to form a compact, and sintering the compact to produce a metal part.

The powder used in the above method of manufacturing a metal part is a collection of a powder having uniform quality. Thus, the method of manufacturing a metal part can produce a metal part having uniform electrical characteristics throughout.

<19> A method of manufacturing a metal part according to another embodiment produces a metal part by metal additive manufacturing using the powder of one of <1> to <7>.

The powder used in the above method of manufacturing a metal part is a collection of a powder having uniform quality. Thus, the method of manufacturing a metal part can produce a metal part having uniform electrical characteristics throughout.

### Description of Embodiments of Present Disclosure

Hereinafter, embodiments of the present disclosure will be recited and described.

### Details of Embodiments of Present Disclosure

Hereinafter, specific examples of the method of manufacturing a powder, the powder, the metal part, and the electrical contact of the present disclosure will be described based on drawings. Hereinafter, the same reference numerals in the drawings indicate the same or corresponding features. The sizes of members illustrated in the drawings are intended to clarify the explanation and do not necessarily show actual dimensions. The present invention is not limited to the examples described below, and is defined by the claims and intends to include any modifications within the scope and meaning equivalent to the claims.

### Embodiment 1

### <<Method of Manufacturing a Powder>>

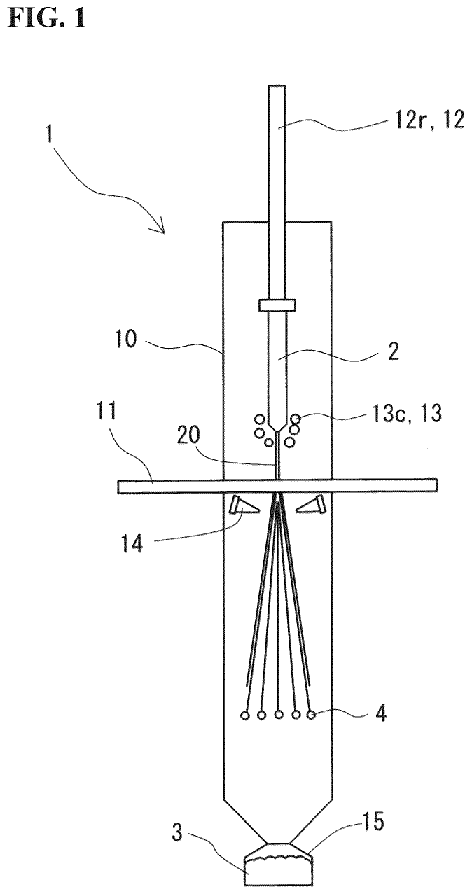

FIG. 1 illustrates an atomizer 1 as an exemplary apparatus for carrying out the method of manufacturing a powder described in the embodiment. The atomizer 1 includes a housing 10, a partition 11, a pushing device 12, a high-frequency induction heating device 13, a nozzle 14, and a recovery pot 15.

The housing 10 separates the working environment from the external environment. The partition 11 is arranged at a central location of the housing 10 in the height direction, and divides the internal space of the housing 10. In the space above the partition 11, a raw material member 2 is melted. Thus, the upper space is brought to a high temperature. A molten metal 20 of the raw material member 2 falls through a hole in the partition 11 to the space below the partition 11. In the space below the partition 11, the molten metal 20 is atomized into minute particles. The inside of the housing 10 is, for example, an inert atmosphere.

The pushing device 12 supplies the raw material member 2, which is elongated, to the high-frequency induction heating device 13. In the drawing, only a rod 12r of the pushing device 12 that is movable in the vertical direction is illustrated. The raw material member 2 is fixed to the tip of the rod 12r. The rod 12r moves downward in accordance with the progress of melting of the raw material member 2. Thus, a predetermined amount of the raw material member 2 is continuously supplied to the high-frequency induction heating device 13.

The high-frequency induction heating device 13 has no crucibles. For example, the high-frequency induction heating device 13 includes a coil 13c, a power line that supplies high-frequency power to the coil 13c, and a control unit that controls the amount of power supplied to the coil 13c. In the drawing, only the coil 13c is illustrated. The magnetic fields generated by the coil 13c melt the raw material member 2 into the molten metal 20 by induction heating, and also stir the molten metal 20.

The nozzle 14 injects a fluid, such as gas or water, in the space below the partition 11. The molten metal 20 scattered by the gas or water is cooled and forms particles 4. The particles 4 accumulate in the recovery pot 15 disposed at the bottom of the housing 10. A powder 3 that is a collection of the particles 4 accumulated at the bottom of the recovery pot 15 may be recovered with, for example, a cyclone recovery machine. With the cyclone recovery machine, fine particles 4 having or smaller than a predetermined grain size are recovered. Coarse particles 4 remain in the recovery pot 15. The powder 3 may be sieved.

The method of manufacturing a powder of the present example includes the following steps. In the present example, the method of manufacturing a powder will be described based on an example using the atomizer 1 illustrated in FIG. 1.
Step A . . . Providing a raw material member 2 containing a first component and a second component.
Step B . . . Melting the raw material member 2 using the high-frequency induction heating device 13 having no crucibles.
Step C . . . Atomizing the molten metal 20 obtained in step B into a powder 3.

Each of the steps will be described in detail below.

### [Step A]

The first component and the second component in the raw material member 2 are, for example, a combination having a two liquid phases separate region in the phase diagram. The first component and the second component are each a metal element or a compound of a metal element. In the present specification, silicon (Si) is included in the metal elements. The first component forms a matrix in the particles 4. In the particles 4, the second component forms precipitates that are dispersed in the matrix. The raw material member 2 may contain incidental impurities.

The raw material member 2 may be composed of a first solid principally containing the first component and a second solid principally containing the second component. In this case, the first component may be contained only in the first solid or may be contained in the first solid and the second solid. Similarly, the second component may be contained only in the second solid or may be contained in the first solid and the second solid. The raw material member 2 may include at least one dissimilar solid having a composition different from those of the first solid and of the second solid.

For example, the raw material member 2 is a compact obtained by compressing an ingredient powder including a powdery first solid and a powdery second solid. The average grain size of the ingredient powder is, for example, 1 μm to 150 μm. When the average grain size is 1 μm or more, the ingredient powder excels in productivity including handleability and cost. Producing the ingredient powder with a small average grain size takes time and effort. When the average grain size of the ingredient powder is 150 μm or less, variations in the content ratios from place to place in the raw material member 2 can be reduced. Thus, the powder 3 produced using the raw material member 2 has uniform quality. The average grain size of the ingredient powder may be 20 μm to 75 μm. The average grain size of the ingredient powder may be measured with a grain size distribution analyzer. In the present example, the average grain size is D50 on mass basis.

For example, the raw material member 2 may be a bundle or a twist of filaments of the first solid and the second solid. The cross-sectional shapes of the first solid and the second solid may be circular, polygonal, or odd-shape, such as star shape. In a cross section perpendicular to the longitudinal direction of the first solid, the cross-sectional area of a single filament of the first solid is, for example, 1 mm² to 7 mm². In a cross section perpendicular to the longitudinal direction of the second solid, the cross-sectional area of a single filament of the second solid is, for example, 1 mm² to 7 mm² The first solid and the second solid having a cross-sectional area of 1 mm² or more excel in productivity including cost. Producing the filaments with a small cross-sectional area takes time and effort. When the cross-sectional area of a single filament of the first solid and that of the second solid are each 7 mm² or less, variations in the content ratios of the first component and the second component from place to place in the raw material member 2 in the longitudinal direction can be reduced. Thus, the powder 3 produced using the raw material member 2 has uniform quality. The cross-sectional area of a single filament of the first solid and that of the second solid may be each 2 mm² to 4 mm² or may be each 2 mm² to 3 mm².

Alternatively, the raw material member 2 may be produced by an infiltration method in which a porous material is filled with a molten metal. In this case, for example, the porous material may be composed of the first component and the molten metal may be composed of the second component. Alternatively, materials including the first component and the second component may be heated to a liquid phase region by, for example, an arc melting method in a water-cooled copper hearth or the like, and the molten metal may be cooled rapidly to give an ingot-shaped raw material member 2. The liquid phase region is a region in which the first component and the second component exist as a single liquid phase without separating from each other.

The two liquid phases separate region in the phase diagram is a region in which the molten metal of the first component and the molten metal of the second component exist separate from each other. The temperatures in the two liquid phases separate region are generally lower than the temperatures in the liquid phase region.

The phase diagram may be a binary phase diagram or a multi-component phase diagram. The first component and the second component are composed of different materials. The melting point of the first component and the melting point of the second component are different from each other. For example, the combination of the first component and the second component is metal element-metal element, metal element-compound of metal element and non-metal element, or compound of metal element and non-metal element-compound of metal element and non-metal element. Specific examples of the combinations of the first component and the second component include silver (Ag)-manganese (Mn), Ag-nickel (Ni), aluminum (Al)-bismuth (Bi), Al-indium (In), Bi-gallium (Ga), Bi-zinc (Zn), copper (Cu)-chromium (Cr), Cu-niobium (Nb), iron (Fe)—Cu, Fe—In, Fe-tin (Sn), lithium (Li)—LiH, Ag—AgO, barium (Ba)—BaO, Bi—BiO, cobalt (Co)—Co₃O₄, Cr—Cr₂O₃, Cu—Cu₂O, Fe—FeO, Ni—NiO, Sn—SnO, Zr—ZrO, and Fe₂O₃—SiO₂. In the above combinations, the first component is written to the left of “-” and the second component is written to the right of “-”. The above combinations include those in which an alloy that exhibits immiscibility in a liquid state, such as Fe—Cu, is in a two liquid phases separate state in a supercooled condition or in the presence of impurities.

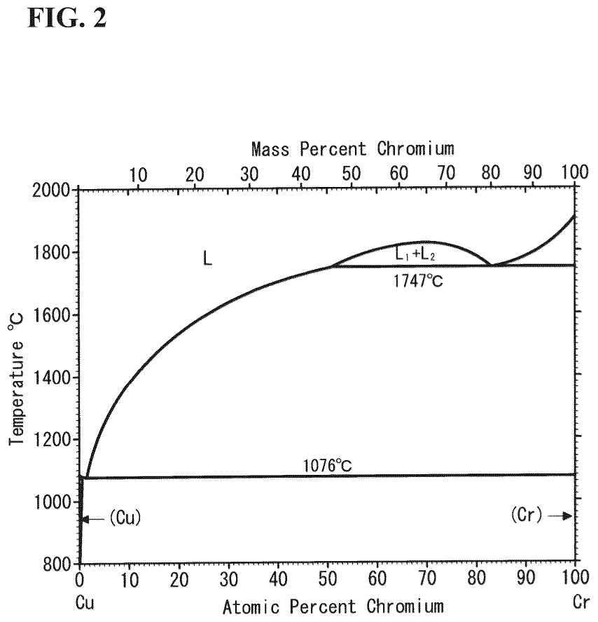

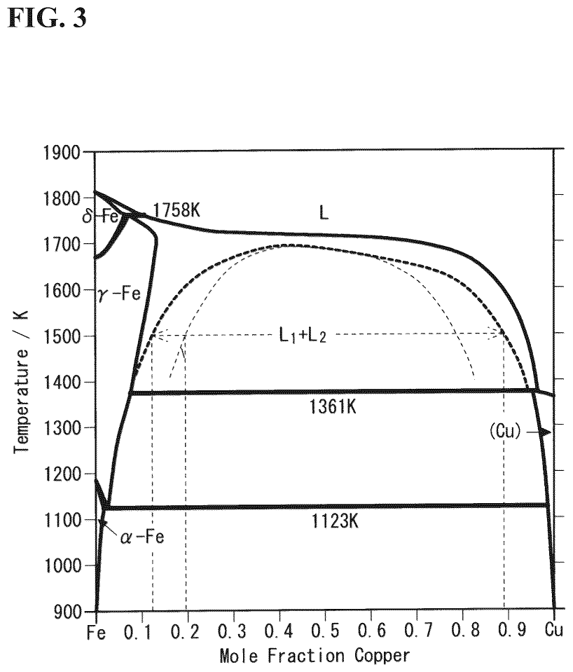

Exemplary phase diagrams are illustrated in FIGS. 2 and 3. FIG. 2 is the Cu—Cr phase diagram. The horizontal axis in FIG. 2 indicates the Cr content in the Cu—Cr alloy. The unit for the lower horizontal axis is atom %, and the unit for the upper horizontal axis is mass %. The vertical axis in FIG. 2 indicates temperature. The unit of temperature is ° C. In the drawing, “L” indicates a liquid phase region, and “L₁+L₂” indicates a two liquid phases separate region. FIG. 3 is the Fe—Cu phase diagram. The horizontal axis in FIG. 3 indicates the molar ratio of Cu in the Fe—Cu alloy, and the vertical axis indicates temperature. The unit of temperature is K. In FIG. 3, the region enclosed by the horizontal line at 1361 K and the thick broken line is a two liquid phases separate region. For example, Fe and Cu are easily caused to separate into two liquid phases by increasing the content ratio of trace elements, such as carbon and oxygen, in Fe—Cu. The scope of the present invention also includes such combinations of components formed with control of trace elements. For purposes, such as to contribute to enhancing product characteristics, other elements may be added to the raw material member 2 as long as such additional elements do not affect or inhibit the formation of the two liquid phases region.

The content ratios of the first component and the second component in the raw material member 2 are content ratios falling in the two liquid phases separate region in the phase diagram. In the Cu—Cr phase diagram illustrated in FIG. 2, when the total content of Cu and Cr contained in the raw material member is taken as 100 mass %, the content of Cr represents 47 mass % to 80 mass % of the total content. The raw material member 2 containing 47 mass % to 80 mass % of Cr can reach a two liquid phases separate state as the temperature of the raw material member 2 increases.

### [Step B]

In step B, the raw material member 2 is melted with the high-frequency induction heating device 13 that have no crucibles. The temperatures in the two liquid phases separate region are lower than the temperatures in the liquid phase region. The high-frequency induction heating device having no crucibles cannot reserve the molten metal 20 and therefore will not heat the molten metal to a temperature in the liquid phase region.

The magnetic fields generated by the high-frequency induction heating device 13 vigorously stir the molten metal 20. Even when the molten metal 20 is in a two liquid phases separate state composed of the molten metal of the first component and the molten metal of the second component, the molten metal of the first component and the molten metal of the second component are vigorously stirred. This stirring creates a state in which the molten metal of the second component is finely dispersed in the molten metal of the first component. During this process, the molten metal 20 is completely liquefied. Thus, the first solid may be an alloy containing both the first component and the second component, and the second solid may be an alloy containing both the first component and the second component. For example, the frequency of the current that operates the high-frequency induction heating device 13 is 100 kHz or more. A high-frequency current of 100 kHz or more quickly raises the temperature of the coil 13c. Furthermore, a high-frequency current of 100 kHz or more allows the molten metal of the first component and the molten metal of the second component to be stirred sufficiently. The frequency may be 125 kHz or more or may be 150 kHz or more.

### [Step C]

In step C, the molten metal 20 is atomized into a powder 3. In the atomization process, a fluid, such as gas or water, is injected from the nozzle 14 toward the molten metal 20. The molten metal 20 is scattered by the gas or water, and the scattered molten metal 20 is rapidly solidified. As a result, a powder 3 consisting of fine particles 4 is obtained. For example, the gas is argon, helium, or nitrogen. The grain size of the particles 4 varies depending on the gas pressure. Furthermore, the cooling rate of the particles 4 varies depending on the type of the fluid, and thereby the internal structure of the particles 4 varies. In particular, the cooling ability varies significantly between a gas, which is a gaseous matter, and water, which is a liquid.

### <<Powder>>

The average grain size of the powder 3 produced by the above method of manufacturing a powder, that is, the average grain size of the particles 4 is, for example, 200 μm or less. When the average grain size is 200 μm or less, pressure molding of the powder can produce a dense compact having few voids. The average grain size of the powder 3 is determined by image analysis using SEM (a scanning electron microscope). The average grain size of the particles 4 may be 100 μm or less, may be 50 μm or less, or may be 10 μm or less. The lower limit of the average grain size of the particles 4 is, for example, 1 μm or more.

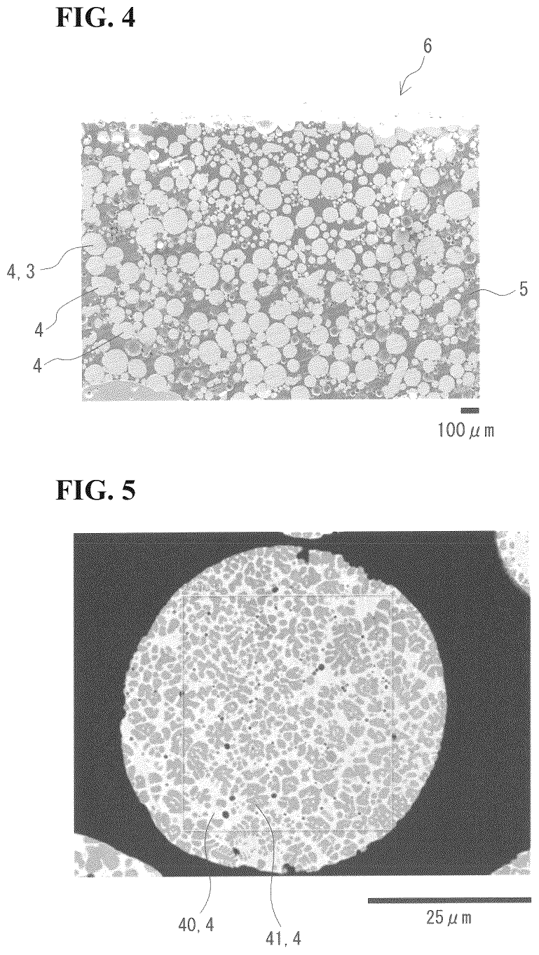

FIG. 4 is a SEM image of a cross section of a sample 6 produced in test example 1 that will be described later. The sample 6 was produced by fixing the powder 3 in a resin 5. In the present specification, the equivalent circle diameter of the particles 4 in the SEM image is the grain size of the particles 4. The equivalent circle diameter is determined as follows. First, the SEM image is binarized and the area of each particle 4 in the field of view is determined. The diameter of a circle having the same size as the area of the particle 4 is the equivalent circle diameter. The average of the equivalent circle diameters of all the particles 4 in the field of view is the average grain size of the powder 3.

The structure of each particle 4 will be described based on FIG. 5. FIG. 5 is a secondary electron image of a particle 4 produced in test example 1 described later. The secondary electron image is obtained by SEM-EDX (energy dispersive X-ray spectroscopy). As illustrated in FIG. 5, the particle 4 includes a matrix 40 and a plurality of precipitates 41 dispersed in the matrix 40. The matrix 40 is principally composed of the first component, and the precipitates 41 are principally composed of the second component. In FIG. 5, the matrix 40 is copper and the precipitates 41 are chromium.

The content ratios of the first component and the second component in the particles 4 are content ratios falling in the two liquid phases region in the phase diagram. The content ratios in the particles 4 may be regarded as similar to the content ratios in the raw material member 2 provided in the method of manufacturing a powder.

The standard error of the content of the first component in the particles 4 on mass basis is 1.2 or less. Furthermore, the standard error of the content of the second component in the particles 4 on mass basis is also 1.2 or less. These indicators show that the variations in the content of the first component and the content of the second component in the particles are small. That is, the powder 3 that satisfies these indexes is composed of a plurality of particles 4 having uniform quality.

The contents of the first component and the second component are determined by SEM-EDX. First, ten or more particles that can accommodate an observation field of view of a particular size are selected from among the particles 4 in the SEM image. A characteristic X-ray spectrum is acquired from the observation field of view of each particle 4 selected. The contents of the first component and the second component are determined from the area of the peak corresponding to the first component and the area of the peak corresponding to the second component in the spectrum. In the present example, the contents of the first component and the second component were automatically determined with X-max 70 and software Aztec ver. 3 manufactured by Oxford Instruments.

For example, the average grain size of the precipitates 41 in each particle 4 is 5 μm or less. This feature is an indicator showing that the precipitates 41 are finely dispersed in each particle 4. This characteristic of the powder 3 leads to enhancements in the quality of compacts obtained by pressure molding the powder 3 and in the quality of metal parts obtained by sintering the compacts. The grain size of the precipitate 41 is the equivalent circle diameter of the precipitate 41 obtained from a SEM-EDX image. The average grain size of the precipitates 41 is the average of the grain sizes of a plurality of precipitates 41 obtained with respect to a predetermined number of randomly extracted particles 4. The predetermined number is 10 or more. For example, the average grain size of the precipitates 41 may be 2 μm or less.

The standard error of the average grain size of the precipitates 41 in the particles 4 is, for example, 0.1 or less. This feature is an indicator showing that the precipitates 41 are dispersed in the particles 4 in the similar state. That is, the powder 3 that satisfies this index is composed of a plurality of particles 4 having uniform quality. The average grain size is measured with respect to the same particles 4 as the particles 4 analyzed to obtain the backscattered electron spectra. The average grain size of the precipitates 41 in each particle 4 is the average of the equivalent circle diameters of all the precipitates 41 present in an observation field of view of a predetermined range of each particle 4. For example, the standard error may be 0.5 or less.

The maximum grain size of the precipitates 41 in the particles 4 is, for example, 20 μm or less. The fact that the maximum grain size of the precipitates 41 in each of the particles 4 included in the powder 3 is 20 μm or less is an indicator showing that the precipitates 41 are finely dispersed in each particle 4. This characteristic of the powder 3 leads to enhancements in the quality of compacts obtained by pressure molding the powder 3 and in the quality of sintered bodies obtained by sintering the compacts. The maximum grain size is measured with respect to the same particles 4 as the particles 4 analyzed to obtain the backscattered electron spectra. For example, the maximum grain size may be 15 μm or less.

### <<Metal Part>>

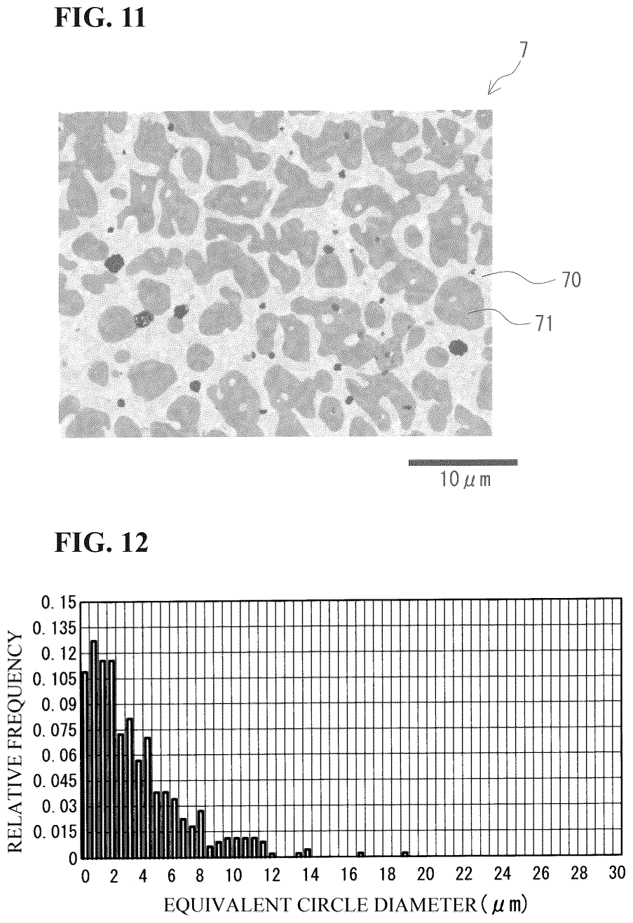

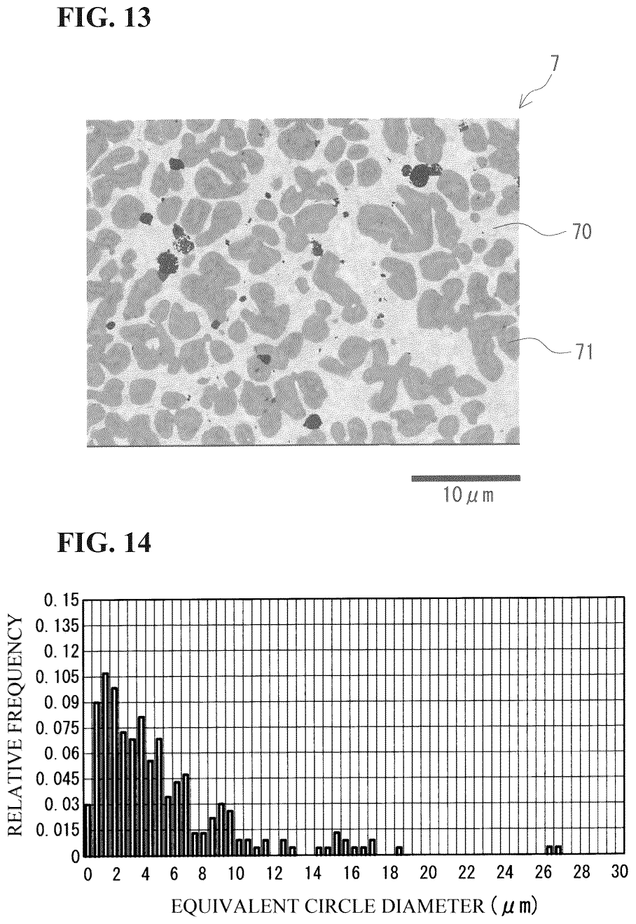

For example, a metal part of the present example is produced using the powder 3 as a raw material. FIG. 11 is a secondary electron image of a cross section of a metal part 7 produced in test example 2 described later. FIG. 13 is a secondary electron image of a cross section of a metal part 7 produced in test example 3 described later. Here, the configuration of the metal part 7 will be described with reference to FIG. 11 as a representative example.

The metal part 7 in FIG. 11 includes a matrix portion 70 and a plurality of island portions 71. The island portions 71 are dispersed in the matrix portion 70. The matrix portion 70 is composed of a first component. The island portions 71 are composed of a second component. The first component and the second component are a combination having a two liquid phases separate region in a phase diagram.

The island portions 71 may have a particulate shape or may have a dendrite shape. When the island portions 71 are dendrites, an island portion 71 that looks like a grain in one cross section may be three-dimensionally connected to an island portion 71 that looks like a grain in another cross section.

The average grain size of the island portions 71 is 10 μm or less. This feature is an indicator showing that the island portions 71 are finely dispersed in the metal part 7. In the present specification, the grain size of the island portion 71 is the equivalent circle diameter of the island portion 71 obtained from a SEM-EDX image. The average grain size of the island portions 71 is the average of the grain sizes of a plurality of island portions 71 obtained with respect to a predetermined number of randomly extracted observation fields of view. The predetermined number is 10 or more. For example, the average grain size of the island portions 71 may be 4 μm or less or may be 3.5 μm or less.

For example, the standard error of the average grain size of the island portions 71 in the metal part 7 is 0.3 or less. This feature is an indicator showing that the island portions 71 are dispersed in the similar state throughout the entirety of the metal part 7. That is, the metal part 7 that satisfies this index has uniform quality throughout. The standard error is determined as follows. First, a plurality of observation fields of view having a particular size are extracted. The size of each observation field of view is, for example, 100 μm×100 μm. For example, the number of observation fields of view is 10. The average grain size, that is, the average equivalent circle diameter of all the island portions 71 in each observation field of view is determined. The standard error is determined based on the average grain sizes obtained with respect to the observation fields of view. The standard error may be 0.25 or less or may be 0.15 or less.

The content ratios of the first component and the second component in the metal part 7 of the present example are equal to the content ratios of the first component and the second component in the powder 3. The content ratios in the metal part 7 are determined in the same manner as the content ratios in the powder 3. That is, the content ratios in the metal part 7 are determined by analyzing a cross section of the metal part 7 by SEM-EDX. When, for example, the first component is copper and the second component is chromium, the content of chromium in the metal part 7 is equal to or more than 47 mass % and equal to 80 mass %. Here, when the ingredient powder for the metal part 7 contains copper powder in addition to the powder 3, the content of chromium in the metal part 7 decreases. The metal part 7 obtained in this case has a chromium content of 30 mass % to less than 47 mass %. When the ingredient powder for the metal part 7 contains chromium powder in addition to the powder 3, the content of chromium in the metal part 7 increases. The metal part 7 obtained in this case has a chromium content of more than 80 mass %.

For example, the maximum grain size of the island portions 71 is 50 μm or less. The metal part 7 free from coarse island portions 71 has uniform quality throughout. For example, the maximum grain size of the island portions 71 may be 40 μm or less or may be 30 μm or less.

### <<Methods of Manufacturing a Metal Part>>

In a first method of manufacturing a metal part, the powder 3 is pressure molded into a compact, and the compact is sintered to give a metal part 7. The pressure of the pressure molding is, for example, 10 MPa (megapascal) to 100 MPa. The sintering temperature is, for example, 800° C. to 1050° C. The atmosphere during sintering is, for example, a vacuum atmosphere.

In a second method of manufacturing a metal part, a metal part 7 is produced by metal additive manufacturing using the powder 3. The metal additive manufacturing apparatus may be of directed energy deposition system or may be of powder bed system. A directed energy deposition apparatus melts the powder 3 with laser light while injecting the powder 3, and stacks the molten metal on top of one another. In a powder bed apparatus, the powder 3 is spread, laser light or an electron beam is applied to the powder 3, and thereby the powder 3 is melted. For example, the average grain size of the powder 3 subjected to metal additive manufacturing is 20 μm to 100 μm. With such an average grain size, the powder 3 is easily melted and consequently the metal part 7 tends to attain uniform electrical characteristics.

When the powder 3 contains copper, blue laser light easily melts the powder 3. This is because copper easily absorbs blue laser light. The output of the blue laser light is, for example, 100 W to 300 W. The sweep speed of the blue laser light is, for example, 5 mm/s to 40 mm/s.

### <<Method of Manufacturing an Electrical Contact Material

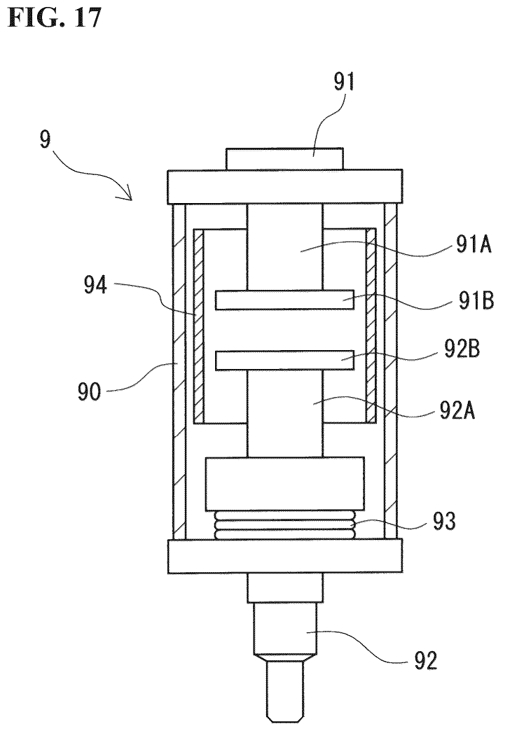

For example, the powder 3 serves as an electrical contact material. Examples of the devices equipped with electrical contacts include gas circuit breakers and vacuum circuit breakers. FIG. 17 is a schematic view of a vacuum circuit breaker 9. The vacuum circuit breaker 9 includes a vacuum valve 90, a stationary terminal 91, a movable terminal 92, a bellows 93, and an arc shield 94. The inside of the vacuum valve 90 is evacuated. The stationary terminal 91 includes an electrode rod 91A and a stationary contact 91B. The movable terminal 92 includes an electrode rod 92A and a movable contact 92B. The movable terminal 92 is configured to move forward and backward along the axial direction of the electrode rod 92A. The bellows 93 expands and contracts along with the movement of the movable terminal 92 and maintains the vacuum inside the vacuum valve 90. The arc shield 94 blocks an arc struck between the stationary contact 91B and the movable contact 92B.

In the vacuum circuit breaker 9, for example, the stationary contact 91B of the stationary terminal 91 and the movable contact 92B of the movable terminal 92 are produced from the powder 3. Specifically, compacts are produced by pressure molding the powder 3. Next, the compacts are sintered to give electrical contact materials. The electrical contact materials are sized to give the stationary contact 91B and the movable contact 92B. The electrical contact material may be subjected to cutting or the like. Alternatively, the stationary contact 91B and the movable contact 92B may be produced with a metal additive manufacturing apparatus, such as an electron beam system or a laser melting system. For example, the electrode rods 91A and 92A may be used as base plates in the metal additive manufacturing, and the stationary contact 91B and the movable contact 92B may be each constructed as one piece with the electrode rod 91A and the electrode rod 92A, respectively. In this case, the materials and the steps that are necessary for joining the electrode rod 91A to the stationary contact 91B, and the electrode rod 92A to the movable contact 92B are omitted.

When the contents of chromium in the stationary contact 91B and in the movable contact 92B are high, an arc struck between the stationary contact 91B and the movable contact 92B is easily extinguished. Thus, the vacuum circuit breaker 9 that includes the stationary contact 91B and the movable contact 92B consisting of a Cu—Cr alloy with a chromium content of 47 mass % to 80 mass % exhibits excellent breaking performance. In the present example, the stationary contact 91B and the movable contact 92B are formed of a structure in which chromium is finely dispersed in a copper matrix. The stationary contact 91B and the movable contact 92B having such a structure easily extinguish an arc struck between them. Thus, the vacuum circuit breaker 9 of the present example attains excellent breaking performance. The powder 3 of the present example may be used as a raw material for the bellows 93.

### Test Example 1

In test example 1, a powder 3 was actually produced using the atomizer 1 illustrated in FIG. 1, and the structure and properties of the powder 3 were studied.

A raw material member 2 was produced by pressure molding copper powder and chromium powder. The copper powder was produced by a water atomization process. The average grain size of the copper powder was 150 μm. The chromium powder was produced by a thermite process. The average grain size of the chromium powder was 150 μm. The average grain sizes of the copper powder and of the chromium powder are D50 measured with a grain size distribution analyzer. D50 is on mass basis. The chromium powder contains alumina as an incidental impurity. The content ratios of the copper powder and the chromium powder in the raw material member 2 were content ratios falling in the two liquid phases separate region in the Cu—Cr phase diagram. Specifically, the content of copper was 50 mass % and the content of chromium was 50 mass % based on the total of copper and chromium in the raw material member 2 taken as 100 mass %.

The pressure molding was performed by cold isostatic pressing (CIP). The inner dimensions of the CIP rubber mold were cylindrical with a diameter of 60 mm and a length of 270 mm. The CIP pressure was 390 MPa.

The raw material member 2 was set in the atomizer 1. The high-frequency induction heating device 13 was operated at a frequency of 125 kHz and a current of 200 mA to melt the raw material member 2. Nitrogen gas was injected from the nozzle 14 to scatter the molten metal 20 falling from the lower end of the raw material member 2. A plurality of particles 4 were thus produced.

The powder 3 accumulated in the recovery pot 15 was recovered, and the recovered powder 3 was sieved. The aperture of the sieve was 150 μm.

Using the powder 3, a sample 6 illustrated in FIG. 4 was produced. The sample 6 is produced by mixing a resin 5 and the powder 3 and curing the resin 5. FIG. 4 is a SEM image, taken by SEM, of a cross section of the sample 6 cut with a focused ion beam.

The average grain size of the powder 3 was measured by image analysis of the SEM image in FIG. 4. The size of the field of view in FIG. 4 was 0.5 mm×0.5 mm. In the image analysis, the SEM image was binarized and all the particles 4 in the field of view were extracted. The diameter of a circle with the same size as the area of the particle 4 was determined. This equivalent circle diameter is regarded as the grain size of the particle 4. The average grain size of the powder 3, that is, the average grain size of the particles 4 is the average of the equivalent circle diameters of all the particles 4 in the field of view. The population of the particles 4 in the present example was 150. The average grain size of the powder 3 in the test example was 120 μm.

Next, the structure of each particle 4 was observed by SEM-EDX. FIG. 5 is a backscattered electron image of a randomly selected particle 4. The white regions in FIG. 5 are a matrix 40 consisting of Cu, the gray regions are precipitates 41 consisting of Cr, and the black dots are alumina. In the particles 4 of the present example, as illustrated in FIG. 5, the precipitates 41 were finely dispersed in the matrix 40.

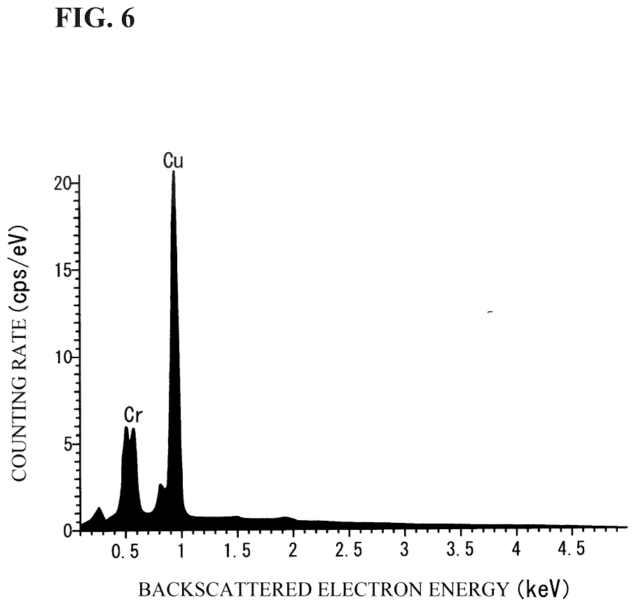

In order to study the uniformity of the particles 4 constituting the powder 3, the copper content and the chromium content in randomly selected ten particles 4 were measured. The particles 4 selected for measurement have a size enough to accommodate a 400 μm² square observation field of view within the outer peripheral contour of the particle 4. The thin rectangle illustrated in FIG. 5 is the observation field of view. A spectrum was acquired with respect to this observation field of view. FIG. 6 is a spectrum of the particle 4 illustrated in FIG. 5. The horizontal axis indicates the energy of backscattered electrons (keV), and the vertical axis indicates the counting rate (cps/eV). The copper content and the chromium content can be determined from this spectrum. However, the spread of the electron beam differs for each element depending on the accelerating voltage of the SEM electron gun, and the results vary depending on the accelerating voltage settings. Thus, the values measured here are merely an index for defining the standard error among the particles. Here, the accelerating voltage was set to 5 kV and an energy dispersive characteristic X-ray analyzer (EDX) was used. In this process, the electron gun and the detection device are set so that a sufficient S/N ratio will be obtained. This setting was made so that the dead time would be approximately 10% to 20% in accordance with the size of the detection device used. Here, JSM-7600F manufactured by JEOL Ltd. was used, the objective lens aperture was 4, the irradiation current was 1 nA, and the process time was 5. The content ratios of the first component and the second component in the whole of the powder 3 are obtained with ICP emission spectrometer ICPS-8100 manufactured by Shimadzu Corporation. The analytical value of the powder 3 produced in the present example was chromium: 50.6 mass %.

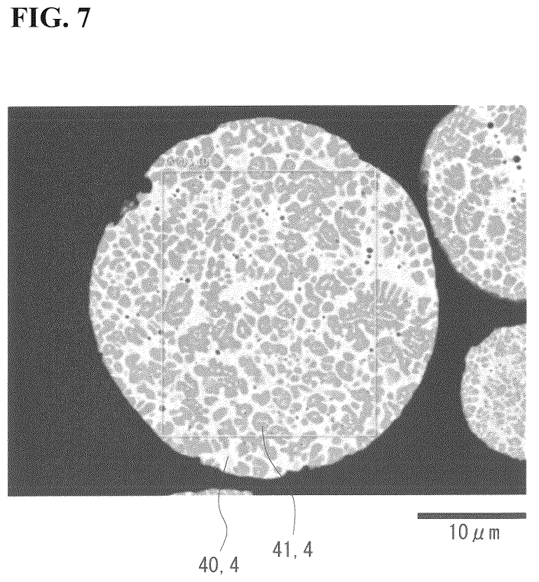

FIG. 7 is a backscattered electron image of a particle 4 different from that illustrated in FIG. 5. The size and the state of dispersion of the precipitates 41 in the particle 4 illustrated in FIG. 7 were substantially the same as in the particle 4 illustrated in FIG. 5. Although not shown in the present specification, the backscattered electron images of the ten particles 4 have very similar appearances.

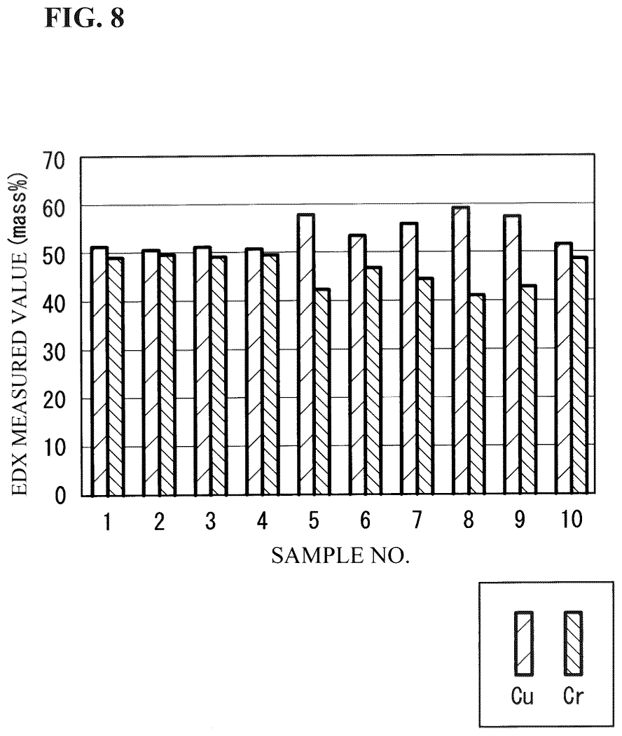

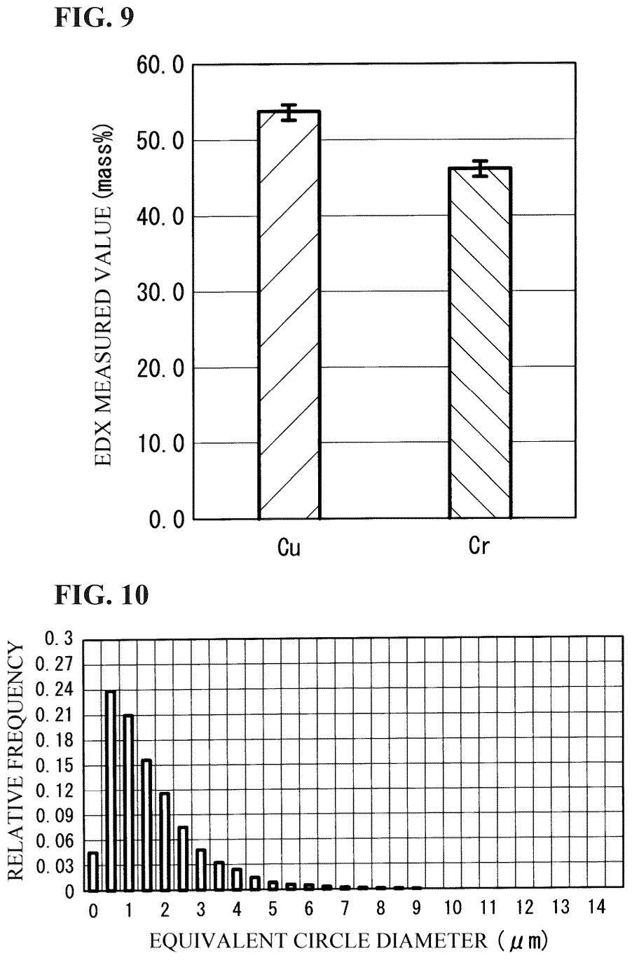

FIG. 8 is a bar graph showing the copper content and the chromium content in each of the ten particles 4. The horizontal axis indicates the sample No., and the vertical axis indicates mass %. The columns with 45° hatching indicate copper contents and the columns with 135° hatching show chromium contents. FIG. 9 is a bar graph showing the average content of copper and the average content of chromium. The error bars in the figure indicate standard errors. The standard error of the average content of copper in the present example was 1.1. The standard error of chromium was also 1.1. The results illustrated in FIGS. 8 and 9 showed that the particles 4 had very small variations in copper content and chromium content.

Next, the grain size of each of the precipitates 41 contained in the particle 4 was measured. FIG. 10 is a graph summarizing the results of the equivalent circle diameter measured of each precipitate 41 in the particle 4 illustrated in FIG. 5. In the present example, the equivalent circle diameter of the precipitate 41 is regarded as the grain size of the precipitate 41. Measurement objects that had an equivalent circle diameter of 0.39 μm or less were not counted as the precipitates 41. In FIG. 10, the horizontal axis indicates the equivalent circle diameter and the vertical axis indicates the relative frequency based on the counts. The unit of the equivalent circle diameter is μm. A column where the equivalent circle diameter is an integer k indicates the number of precipitates 41 having an equivalent circle diameter of k μm to k+less than 0.5 μm. For example, the column where the equivalent circle diameter is 0 μm indicates the number of precipitates 41 having an equivalent circle diameter of 0 to less than 0.5 μm. A column where the equivalent circle diameter is between an integer k and an integer k+1 indicates the number of precipitates 41 having an equivalent circle diameter of k+0.5 μm to k μm. For example, the column where the equivalent circle diameter is between 0 μm and 1 μm indicates the number of precipitates 41 having an equivalent circle diameter of 0.5 μm to 1.0 μm.

Although not shown in the present specification, the nine particles 4 other than the particle 4 illustrated in FIG. 5 gave graphs similar to the graph illustrated in FIG. 10. Table 1 describes the average grain size and the maximum grain size of the precipitates 41 in each of the ten particles 4. The ten particles 4 were free from precipitates 41 larger than 20 μm.

TABLE 1

| | Average grain size | Maximum grain size |
|---|---|---|
| No. | of precipitates | of precipitates |
| 1 | 1.67 | 12.96 |
| 2 | 1.53 | 5.87 |
| 3 | 1.74 | 11.43 |
| 4 | 1.71 | 9.54 |
| 5 | 1.59 | 8.30 |
| 6 | 2.21 | 10.36 |
| 7 | 1.74 | 8.30 |
| 8 | 1.73 | 9.76 |
| 9 | 1.79 | 12.60 |
| 10 | 1.49 | 10.55 |
| Average | 1.72 | |
| Standard deviation | 0.19 | |
| Standard error | 0.06 | |

“Average grain size of precipitates” in Table 1 is the average of the precipitates 41 contained in each particle 4. “Average” is the average of the ten average grain sizes, that is, the average grain size of the precipitates 41 in the whole of the powder 3. The standard deviation of the ten average grain sizes was 0.19, and the standard error was 0.06. The fact that the standard error of the average grain size of the precipitates 41 in the particles 4 is 0.1 or less is an indicator showing that the precipitates 41 are dispersed in the particles 4 in the similar state. This characteristic of the powder 3 leads to enhancements in the quality of compacts obtained by pressure molding the powder 3 and in the quality of metal parts 7 obtained by sintering the compacts.

### Test Example 2

In test example 2, a metal part 7 was produced from the powder 3 of test example 1, and the structure of the metal part 7 was studied.

First, a compact was produced by pressure molding the powder 3. The pressure molding was performed using a hydraulic press. The surface pressure of the hydraulic press was 20 tons/cm² (1961 MPa). The compact was cylindrical with a diameter of 30 mm. Next, the compact was vacuum sintered at 900° C. to give a metal part 7.

A cross section of the metal part 7 produced was photographed with SEM, and the structure of the cross section of the metal part 7 was observed. The cross section is polished with colloidal silica. The number of observation fields of view was 10. The size of the observation field of view was 100 μm×100 μm. FIG. 11 is a backscattered electron image of one of the ten observation fields of view. The backscattered electron images of the ten observation fields of view are similar. The conditions for acquiring the backscattered electron images were the same as in test example 1. The magnification in FIG. 11 is 3000 times. The image in FIG. 11 is a portion of the observation field of view and is narrower than the observation field of view.

The grain size, that is, the equivalent circle diameter of the island portions 71 was measured with respect to the backscattered electron images of the cross section. The method for measuring the equivalent circle diameter of the island portions 71 is the same as the method for measuring the precipitates 41 in test example 1. Measurement objects having an equivalent circle diameter of 0.28 μm or less were not counted as the island portions 71. FIG. 12 is a graph summarizing the measurement results of the equivalent circle diameter of the island portions 71 in the observation field of view illustrated in FIG. 11. The way of reading FIG. 12 is the same as that of FIG. 10. Table 2 describes the average grain size and the maximum grain size of the island portions 71 obtained from each of the ten observation fields of view. The way of reading Table 2 is the same as that of Table 1.

TABLE 2

| | Average grain size | Maximum grain size |
|---|---|---|
| No. | of island portions | of island portions |
| 1 | 2.80 | 18.37 |
| 2 | 4.57 | 45.26 |
| 3 | 3.72 | 19.60 |
| 4 | 4.31 | 27.15 |
| 5 | 2.59 | 14.87 |
| 6 | 3.62 | 22.80 |
| 7 | 2.82 | 16.43 |
| 8 | 3.29 | 16.54 |
| 9 | 3.03 | 18.37 |
| 10 | 2.73 | 18.48 |
| Average | 3.35 | |
| Standard deviation | 0.65 | |
| Standard error | 0.21 | |

“Average” in Table 2, that is, the average grain size of all the island portions 71 contained in the metal part 7 was 3.35 μm. The fact that the average grain size of the island portions 71 is 10 μm or less is an indicator showing that the island portions 71 are finely dispersed in the matrix portion 70. Furthermore, the standard deviation of the average grain sizes of the ten observation fields of view was 0.65, and the standard error was 0.21. The fact that the standard error is 0.3 or less is an indicator showing that the island portions 71 are dispersed in the similar state throughout the entirety of the metal part 7. Furthermore, the maximum grain size of the island portions 71 was 45.26 μm. The fact that the maximum grain size is 50 μm or less is an indicator showing that the metal part 7 has uniform quality throughout. Thus, it has been shown that the metal part 7 in test example 2 has uniform quality throughout.

### Test Example 3

In test example 3, a metal part 7 different from that of test example 2 was produced, and the structure of the metal part 7 was studied. Test example 3 differed from test example 2 only in that the vacuum sintering temperature was 1000° C.

FIG. 13 is a backscattered electron image of one observation field of view of a cross section of the metal part 7 of the present example. The magnification in FIG. 13 is 3000 times. FIG. 14 is a graph summarizing the measurement results of the equivalent circle diameter of the island portions 71 in the observation field of view illustrated in FIG. 13. In the present example, ten different observation fields of view were studied. Table 3 describes the average grain size and the maximum grain size of the island portions 71 obtained from each of the ten observation fields of view.

TABLE 3

| | Average grain size | Maximum grain size |
|---|---|---|
| No. | of island portions | of island portions |
| 1 | 3.86 | 26.87 |
| 2 | 3.53 | 24.96 |
| 3 | 4.28 | 30.47 |
| 4 | 3.70 | 27.70 |
| 5 | 3.90 | 41.10 |
| 6 | 4.23 | 28.75 |
| 7 | 3.02 | 16.10 |
| 8 | 3.13 | 23.90 |
| 9 | 3.65 | 18.27 |
| 10 | 4.13 | 25.85 |
| Average | 3.74 | |
| Standard deviation | 0.41 | |
| Standard error | 0.13 | |

“Average” in Table 3, that is, the average grain size of all the island portions 71 contained in the metal part 7 was 3.74 μm. The standard deviation and the standard error were 0.41 and 0.13, respectively. Thus, it has been shown that the metal part 7 in test example 3 also has uniform quality throughout.

The average grain size of all the island portions 71 in test example 3 was slightly larger than the average grain size of all the island portions 71 in test example 2. Furthermore, the average of the maximum grain sizes of the ten observation fields of view in test example 3 was also slightly larger than the average of the maximum grain sizes of the ten observation fields of view in test example 2. The difference between test example 3 and test example 2 resides only in vacuum sintering temperature. Thus, it has been found that the island portions 71 tend to be coarsened with increasing vacuum sintering temperature.

### Test Example 4

In test example 4, a metal part 7 was produced by metal additive manufacturing of the powder 3 of test example 1, and the structure of the metal part 7 was studied.

The metal additive manufacturing apparatus was ALPION Type Blue manufactured by MURATANI MACHINE MANUFACTURE Co., Ltd. This metal additive manufacturing apparatus is configured to perform modeling by applying three beams of blue laser light while injecting the powder 3. The maximum output and the wavelength of each beam of blue laser light are 100 W and 445 nm.

The metal additive manufacturing conditions in the present example are as
follows.
Average grain size of powder 3 . . . 80 μm
Injection rate of powder 3 . . . 10 g/min
Output of blue laser light . . . 100 W
Sweep speed of blue laser light . . . 40 mm/s

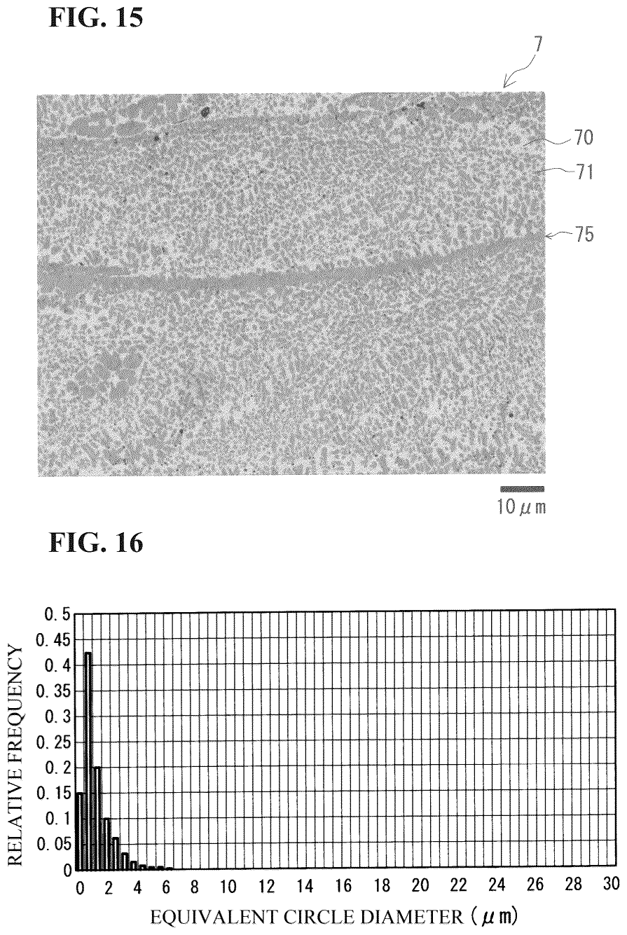

A cross section of the metal part 7 produced was observed in the same manner as in test examples 2 and 3. FIG. 15 is a backscattered electron image of an observation field of view of the cross section of the metal part 7 of the present example. The magnification in FIG. 15 is 1000 times. FIG. 16 is a graph summarizing the measurement results of the equivalent circle diameter of the island portions 71 obtained from the observation field of view illustrated in FIG. 15. In the present example, ten different observation fields of view were studied. Table 4 describes the average grain size and the maximum grain size of the island portions 71 obtained from each of the ten observation fields of view.

TABLE 4

| | Average grain size | Maximum grain size |
|---|---|---|
| No. | of island portions | of island portions |
| 1 | 1.14 | 25.72 |
| 2 | 1.30 | 24.78 |
| 3 | 1.27 | 27.67 |
| 4 | 1.04 | 28.43 |
| 5 | 1.10 | 28.13 |
| 6 | 1.09 | 34.42 |
| 7 | 1.19 | 32.05 |
| 8 | 1.20 | 22.51 |
| 9 | 1.07 | 15.83 |
| 10 | 0.99 | 41.62 |
| Average | 1.14 | |
| Standard deviation | 0.09 | |
| Standard error | 0.03 | |

“Average” in Table 4, that is, the average grain size of all the island portions 71 contained in the metal part 7 was 1.14 μm. The fact that the average grain size of the island portions 71 is 10 μm or less is an indicator showing that the island portions 71 are finely dispersed in the matrix portion 70. Furthermore, the standard deviation of the average grain sizes of the ten observation fields of view was 0.09, and the standard error was 0.03. The fact that the standard error is 0.3 or less is an indicator showing that the island portions 71 are dispersed in the similar state throughout the entirety of the metal part 7. Furthermore, the maximum grain size of the island portions 71 was 41.62 μm. The fact that the maximum grain size is 50 μm or less is an indicator showing that the metal part 7 has uniform quality throughout. Thus, it has been shown that the metal part 7 in test example 4 has uniform quality throughout.

As illustrated in the photograph of FIG. 15, metal additive manufacturing tends to form a concentrated layer 75 that is relatively rich in island portions 71 between layers. This is because when a new layer is formed on an existing layer, the molten metal that will constitute the new layer tends to be cooled by the existing layer. Since chromium contained in the molten metal has a higher melting point than copper, cooling of the molten metal gives rise to solidification of chromium before copper. Thus, a concentrated layer 75 occurs between the existing layer and the new layer.

When the metal parts 7 produced by metal additive manufacturing are applied to the stationary contact 91B and the movable contact 92B in FIG. 17, it is recommended to arrange the concentrated layer 75 along the direction in which the current flows. In this case, the influence of the concentrated layer 75 on the function of the vacuum circuit breaker 9 can be reduced.

### REFERENCE SIGNS LIST

1 atomizer
   10 housing
   11 partition
   12 pushing device, 12r rod
   13 high-frequency induction heating device, 13c coil
   14 nozzle
   15 recovery pot
2 raw material member
   20 molten metal
3 powder
4 particle
   40 matrix
   41 precipitate
5 resin
6 sample
7 metal part
   70 matrix portion, 71 island portion
   75 concentrated layer
9 vacuum circuit breaker
   90 vacuum valve
   91 stationary terminal, 91A electrode rod, 91B stationary contact
   92 movable terminal, 92A electrode rod, 92B movable contact
   93 bellows, 94 arc shield

1. A powder comprising:
a collection of a plurality of particles containing metal elements,
the particles each comprising a matrix and a plurality of precipitates dispersed in the matrix, wherein
the matrix comprises a first component,
the precipitates each comprises a second component,
the first component and the second component are a combination having a two liquid phases separate region in a phase diagram,
the content ratios of the first component and the second component are content ratios falling in the two liquid phases separate region,
the standard error of the content of the first component in the particles on mass basis being 1.2 or less,
the standard error of the content of the second component in the particles on mass basis being 1.2 or less, and
the average grain size of the precipitates being 5 μm or less.

2. The powder according to claim 1, wherein the standard error of the average grain size of the precipitates in the particles is 0.1 or less.

3. The powder according to claim 1, wherein the average grain size of the particles is 200 μm or less.

4. The powder according to claim 1, wherein the maximum grain size of the precipitates is 20 μm or less.

5. The powder according to claim 1, wherein the first component is copper and the second component is chromium.

6. A metal part containing metal elements, the metal part comprising:
a matrix portion and a plurality of island portions dispersed in the matrix portion, wherein the matrix portion comprises a first component,
the island portions each comprises a second component,
the first component and the second component are a combination having a two liquid phases separate region in a phase diagram,
the content ratios of the first component and the second component are content ratios falling in a two liquid phases separate region in a phase diagram,
the average grain size of the island portions is 10 μm or less, and
the standard error of the average grain size of the island portions in a plurality of different observation fields of view is 0.3 or less.

7. The powder according to claim 6, wherein the first component is copper and the second component is chromium.

8. An electrical contact being composed of the metal part according to claim 6.

9. A method of manufacturing a powder, the method comprising:
step A of providing a raw material member comprising a first component and a second component;
step B of melting the raw material member with a high-frequency induction heating device having no crucibles; and
step C of atomizing a molten metal obtained in step B into a powder, wherein the first component and the second component are a combination having a two liquid phases separate region in a phase diagram,
the content ratios of the first component and the second component in the raw material member are content ratios falling in the two liquid phases separate region, and
the temperature of the molten metal is a temperature in the two liquid phases separate region in the phase diagram.

10. The method of manufacturing a powder according to claim 9, wherein the raw material member is a compact comprising a powdery first solid principally containing the first component and a powdery second solid principally containing the second component.

11. The method of manufacturing a powder according to claim 9, wherein the first component is copper and the second component is chromium.

12. A method of manufacturing a metal part, the method comprising:
pressure molding the powder according to claim 1 to form a compact, and sintering the compact to produce a metal part.

13. A method of manufacturing a metal part, wherein
the method produces a metal part by metal additive manufacturing using the powder according to claim 1.

14. The powder according to claim 2, wherein the average grain size of the particles is 200 μm or less.

15. The powder according to claim 2, wherein the maximum grain size of the precipitates is 20 μm or less.

16. The powder according to claim 2, wherein the first component is copper and the second component is chromium.

17. An electrical contact being composed of the metal part according to claim 7.

18. The method of manufacturing a powder according to claim 10, wherein the first component is copper and the second component is chromium.

19. A method of manufacturing a metal part, the method comprising:
pressure molding the powder according to claim 2 to form a compact, and sintering the compact to produce a metal part.

20. A method of manufacturing a metal part, wherein
the method produces a metal part by metal additive manufacturing using the powder according to claim 2.
